(19) United States
(12) Patent Application Publication
(10) Pub. No.: US 2013/0000882 A1
(43) Pub. Date: Jan. 3, 2013

(54) METHOD AND ARRANGEMENT FOR USING LOW-ENERGY SOURCE FOR CONTROLLING AIR TEMPERATURE IN ROOM SPACE

(76) Inventor: Erkki-Jussi Panula, Seinajoki (FI)

(21) Appl. No.: 13/634,024

(22) PCT Filed: Apr. 26, 2011
(86) PCT No.: PCT/FI2011/050372

§ 371 Date: Sep. 11, 2012

(30) Foreign Application Priority Data
Apr. 27, 2010 (FI) 20105458

(51) Int. Cl. G05D 23/00

(52) U.S. Cl. 165/287

(57) ABSTRACT

The present invention relates to a method and arrangement for using a low-energy source for controlling the air temperature in a room space (5). In the invention, the ratio of the desired inside air temperature in the room space (5) to the outside air (10) temperature is compared. Furthermore the temperature of a heat transfer liquid coming from an extraction circuit (1) is determined. On the basis of these detected temperature levels, heat energy of the heat transfer liquid is regulated, if necessary, after which the heat transfer liquid is channelled to a supply air radiator (15) controlling the temperature of air (7) to be supplied to the room space (5) in order to control this air temperature. At the end of the circulation, the heat transfer liquid is channelled via a return circuit (3) of means back to the extraction circuit (1).

### BACKGROUND OF THE INVENTION

The present invention relates to a method according to the preamble of claim 1 for using a low-energy source for controlling the air temperature in a room space. The invention also relates to an arrangement according to the preamble of claim 8 for performing such a method.

Apparatuses for heating, cooling and ventilation, which utilise the available energy sources only to a limited extent, are previously known. Usually these apparatuses utilise energy from the ground, air or the sun, but only few solutions have managed to utilise several energy sources simultaneously or alternatively.

Particularly interesting in this context are heating and cooling systems based on refrigeration techniques, which have been used in different forms for decades. Refrigeration apparatuses may be used for removing and transferring excess heat from a room space to the outside. The room space may also be heated with these apparatuses, when the refrigeration apparatus has a heat energy source—outside air, air to be supplied to the room space, air to be removed from the room space, or the ground—that can be cooled. The most typical devices for heating room spaces by supplying heat from the ground or the outside air are ground-source and air-source heat pumps. Solutions utilising heat energy of the room space include various exhaust air heat pumps, the names of which reveal the primary heat source they use.

However, these known solutions have several weaknesses and problems. The ability of a conventional air-source heat pump to transfer heat energy from the outside air to room spaces or a water accumulator is limited. On the other hand, an exhaust air heat pump that serves as the only heating device is only effective at temperatures higher than about minus five degrees. At lower temperatures, additional heating, most commonly direct electric heating, is required for maintaining the temperature of the room spaces of a building.

When refrigeration technology is applied, electric power is always needed for generating heat and, in particular, cold. In heat production, the quantity of electricity depends particularly on the temperature of the heat energy source. Usually when the temperature of the heat energy source is approximately 0° C., 1 kW of electric power is sufficient for generating 3 kW of heat. In cooling, with 1 kW of electric power, usually only 2.5 to 1.5 kW of cold can be generated, depending on the cooling demand of the space to be cooled.

In addition to these refrigeration apparatuses, various passive panels or pipes collecting heat energy from solar radiation heat are known to be utilised, these being mainly suitable for heating household water in summer. From these apparatuses, the heat energy is transferred by means of a heat- and frost-resisting liquid to an accumulator connected to the system. Outside the solar heating period, the temperature of the accumulator must usually be maintained by other heat production means, such as a heat pump. In spring and autumn, when the heat energy from the sun is not sufficient for heating household water, it may nevertheless be used for raising the temperature of the heat transfer liquid of the ground loop and, thus, for increasing the efficiency of the heat pump.

All devices described above are mainly used in heat production, but they may also be used for decreasing the temperature of a room space in the above manner. A problem of applying refrigeration technology is the electric power it requires. A problem of cooling techniques in particular is in most cases how to utilise the electrically produced heat energy.

### BRIEF DESCRIPTION OF THE INVENTION

It is an object of the invention to develop a method and an arrangement implementing the method in such a manner that the above-mentioned problems are at least mainly solved. Thus, the present heat regulation method and arrangement utilise heat energy from the ground, the sun or exiting through the envelope of a building for heating household water or air to be supplied to the room spaces of the building, for example.

The object of the invention is achieved with a method and arrangement that are characterized by what is stated in independent claims 1 and 8. The preferred embodiments of the invention are disclosed in the dependent claims.

In the method and arrangement of the invention, an extraction circuit for a low-energy source is used for transferring the necessary heating and cooling transfer liquid. In addition, by means of the heat transfer liquid obtained from the ground and usually having a temperature of 0 to 10° C. in Finland, heat is recovered from the air to be removed from a room space, if the purpose is to heat the air to be supplied to the room spaces.

In the following, the meaning and use of a means collecting heat energy from a heat source, conventionally called a “ground loop”, will be extended by introducing a term “extraction circuit”, by which heat energy can be collected in a conventional manner from the ground or bodies of water but also from other energy sources, such as a district heating network, or different spaces of a building.

The invention provides considerable advantages. Heat energy from the air to be removed from the room spaces may be utilised more efficiently than before for controlling the temperature of air to be supplied to the room spaces. The air to be removed from the room space and supplied to an exhaust duct leading outdoors releases a big portion of its heat energy to a liquid radiator of the arrangement according to the invention. Depending on the transfer surface of the liquid radiator recovering the heat energy and the outside air temperature, the temperature of the air to be removed from the room space is 1 to 7° C. when the air to be removed is transferred to the exhaust duct. Heat energy obtained from the air to be removed from the room space may be used for heating the heat transfer liquid supplied from the extracting circuit, if its temperature is lower than that of the air to be removed from the room space and if the supply air radiator controlling the temperature of the air to be supplied to the room space has a heat demand.

If the heat content of the heat transfer liquid obtained from the extraction circuit is still not sufficient for heating air to be supplied to the room space to a desired temperature, the present method and arrangement allows the supply of additional heat from the accumulator of the heat exchanger means connected to the arrangement. In this way, it is always possible to raise the temperature of the heat transfer liquid to a sufficiently high level to achieve the target temperature.

In the present solution, the flow of heat transfer liquid may be further divided into at least two paths, leading to reasonable flow rates in both the transfer pipes of the heating system and, in particular, the transfer pipe leading to the liquid radiator that collects heat from the air to be removed from the room space and releases heat to the air to be supplied to the room space. In this case, the heat transfer liquid passing through the liquid radiator for the exhaust air may finally be led directly to the soil without disturbing the rest of the heat recovery system.

By leading the air collected or supplied to the attic of a building via the above-mentioned liquid radiator or a radiator specifically designed for this purpose to the outside, the heat energy of this air may also be recovered.

It is an object of the method and arrangement of the invention to primarily utilise energy obtained from the ground in heating and cooling so that the consumption of electricity is as low as possible. However, the invention also allows the utilisation of energy from the sun and the structures of a building whenever it is possible in terms of heating technology. Only one pump is needed for collecting the energy of the air to be removed from the room space, heating the air to be supplied to the room space and maintaining the operation of the extraction circuit. A separate charging pump is only required for utilising the heat of the accumulator of the arrangement for heating the air to be supplied to the room space.

In summertime, the air to be supplied to the room space may be cooled and dried by conveying a heat transfer liquid having a low temperature of +5 to 10° C. and obtained from the extraction circuit to the supply air radiator, whereby the air that has come from the supply air radiator to a heat recovery section of a ventilation machine has cooled to +10 to 18° C. At the same time, the air to be supplied to the room space has cooled and released a big portion of humidity of the outside air it has carried, wherefore it is also possible to decrease the inside air humidity. In the heat recovery section, the air temperature may be raised again, because heat energy may be transferred from the air to be removed from the room space to the air to be supplied to the room space. Consequently, there is little need or no need to post-heat the air to be supplied to the room spaces.

Other advantages of the invention are presented in the following in connection with a more detailed description of special embodiments of the invention.

### BRIEF DESCRIPTION OF THE FIGURES

The invention will now be described in greater detail in connection with preferred embodiments and with reference to the accompanying drawings, in which:

FIG. 1 shows a site of application of the invention;

FIG. 2 shows a second embodiment of air flow at the site of application of the invention;

FIG. 3 shows a schematic operating diagram of a first embodiment of the invention;

FIG. 4 shows a schematic operating diagram of a second embodiment of the invention; FIG. 5 shows a schematic operating diagram of a third embodiment of the invention; and

FIG. 6 shows an embodiment of the arrangement for utilising additional energy in the attic.

### DETAILED DESCRIPTION OF PREFERRED EMBODIMENTS

In the present figures, the method and arrangement for using a low-energy source for controlling the air temperature in a room space are not shown in scale, but the figures are schematics that present a general structure and operation of the preferred embodiments. The structural parts indicated by reference numbers in the figures then correspond to the structural parts marked with reference numbers in this specification.

The present method is applied to an arrangement for collecting low energy, the arrangement typically comprising an extraction circuit 1, in which a special heat transfer liquid is circulated, which is used for conveying heat energy obtained from different heat sources, such as the ground, rock, sediments of water bodies, or water bodies. It is naturally also possible to utilise any other heat source releasing heat energy to the heat transfer liquid. The extraction circuit is also connected to supply and return circuits 2 and 3, where the heat transfer liquid is circulated to recover heat energy accumulated in the heat transfer liquid in heat exchanger means with different structures and functions and in accumulators connected to them.

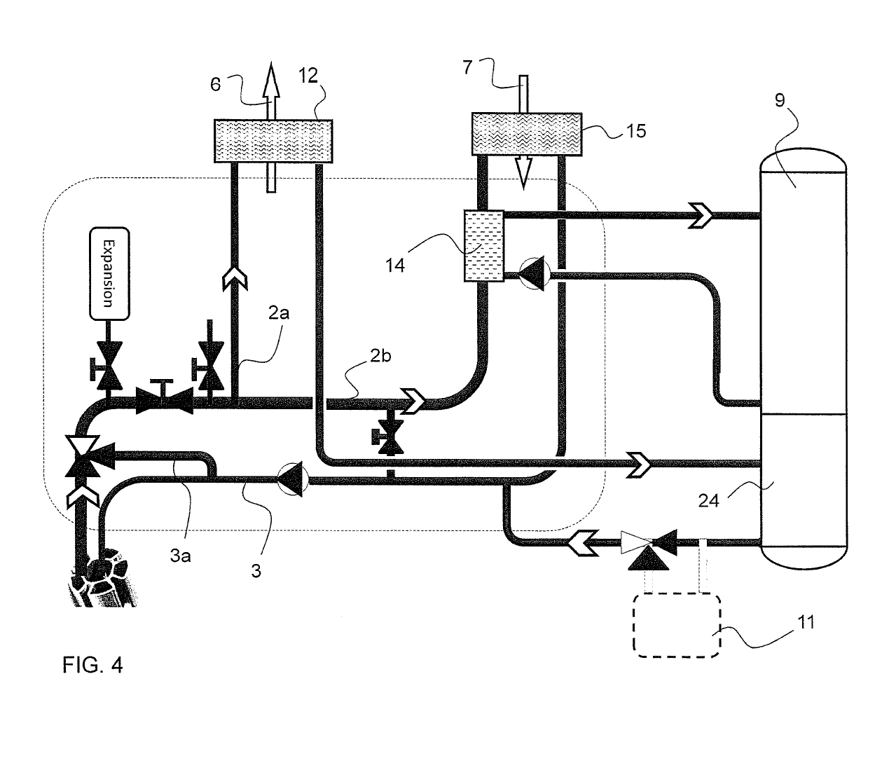

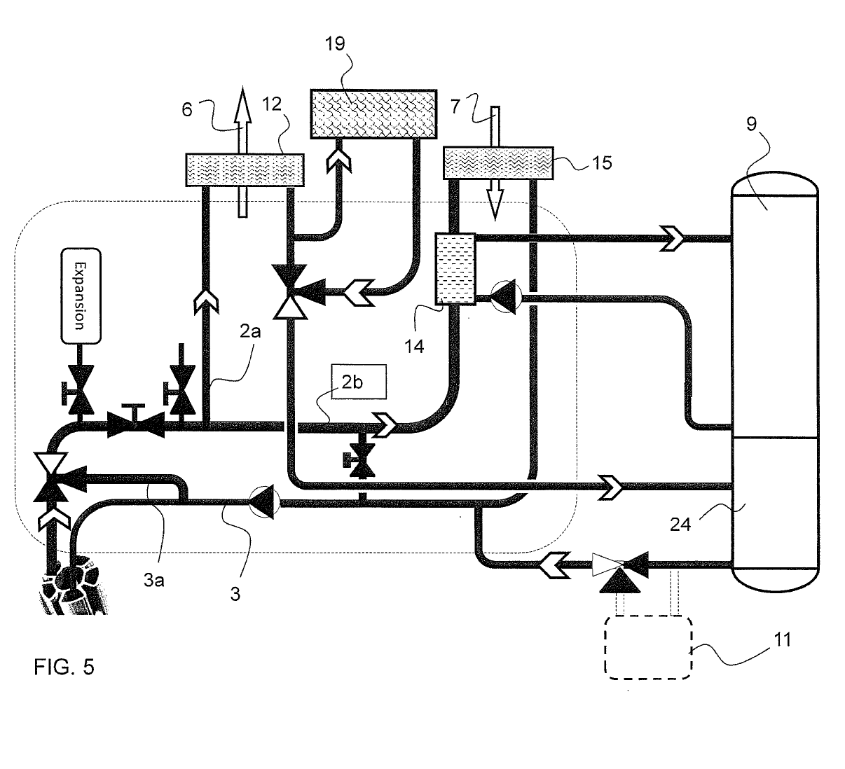

In the arrangement, the heat transfer liquid is circulated by, for example, an effective extraction circuit pump 4 as shown in FIG. 4, which is controlled by a control system known per se, which controls the movement of the heat transfer liquid in both the extraction circuit 1 and the supply circuit 2 connected thereto.

What is characteristic of the arrangement is that heat energy obtained from air 6 to be removed from one or more room spaces 5 of the application site is used for heating air 7 to be supplied to the room spaces. If the heat energy recovered from the exhaust air is not sufficient for heating the air to be supplied to the room space to a desired temperature level, it is possible to utilise additional energy obtained from an accumulator 9 of a heat exchanger means 8 of the arrangement for raising the temperature of the heat transfer liquid to achieve the target temperature set to a sufficiently high level.

Although it is mentioned in this context that the air 6 to be removed consists of air mass to be removed from one or more room spaces 5, the air to be removed may naturally be any air mass to be removed from the building or to be circulated in the arrangement. Examples of these include air heated by a fireplace in a building or by combustion gases removed from the fireplace, exhaust air of a sauna, or air heated in some other manner in a building.

Low energy can be utilised by the present arrangement in such a manner that, for instance, the ratio of the desired inside air temperature in the room spaces 5 to the outside air 10 temperature is determined first. After this, the temperature of the heat transfer liquid coming from the extraction circuit 1 to the supply circuit 2 is determined. Unlike usually, in this arrangement the heat transfer liquid is not supplied directly to an evaporator 11 of a heat pump in the heat exchanger means 8, for example, where it would immediately release its heat energy content. Instead, the heat transfer liquid is first utilised at least partly for controlling the temperature of the air 7 to be supplied to the room spaces.

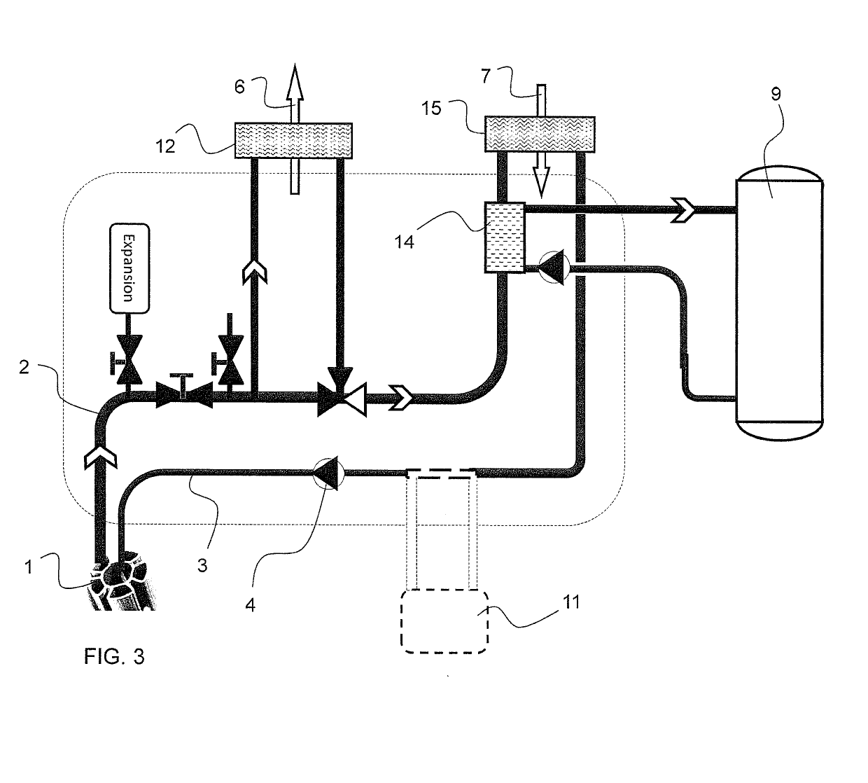

This is carried out in such a manner that when the inside temperature of the room spaces 5 is higher than the outside air 10 temperature and the temperature of the heat transfer liquid is low compared to the heating demand of the air 7 to be supplied from the outside to the room spaces, the heat transfer liquid is in this arrangement supplied, for instance, to an additional circulation as shown by FIG. 3, i.e. to a liquid radiator 12 recovering heat from the flow of air 6 to be removed from the room spaces by utilising control devices known per se. Such a liquid radiator known per se is thus arranged in either an exhaust duct 13 leading from the room spaces to the outside or in connection with it, in which case it recovers a predetermined energy content from the air 6 to be removed. In the present arrangement, this energy content is transferred in the form of heat energy to the heat transfer liquid.

If the heat energy content of the heat transfer liquid is still too low in terms of the heating demand of the air 7 to be supplied to the room space, the heat transfer liquid is supplied further to a heating circuit 14 connected to the accumulator 9 of the heat exchanger means 8, by which the target temperature level may finally be achieved.

The heat transfer liquid having the target temperature level is then supplied to a supply air radiator 15 controlling the temperature of the air 7 to be supplied to the room space 5. In the supply air radiator, heat energy is transferred from the heat transfer liquid to the air to be supplied to the room space, and its temperature can be set separately to a definable level to maintain a substantially even inside temperature in the room space and to avoid the feeling of draught caused by the air to be supplied to the room space.

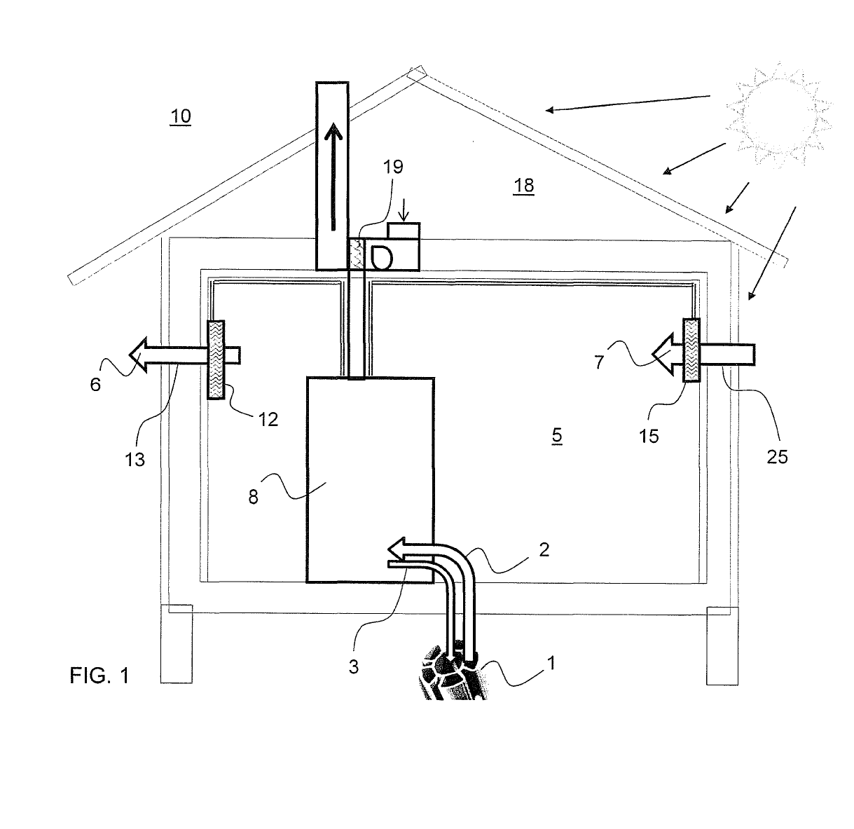

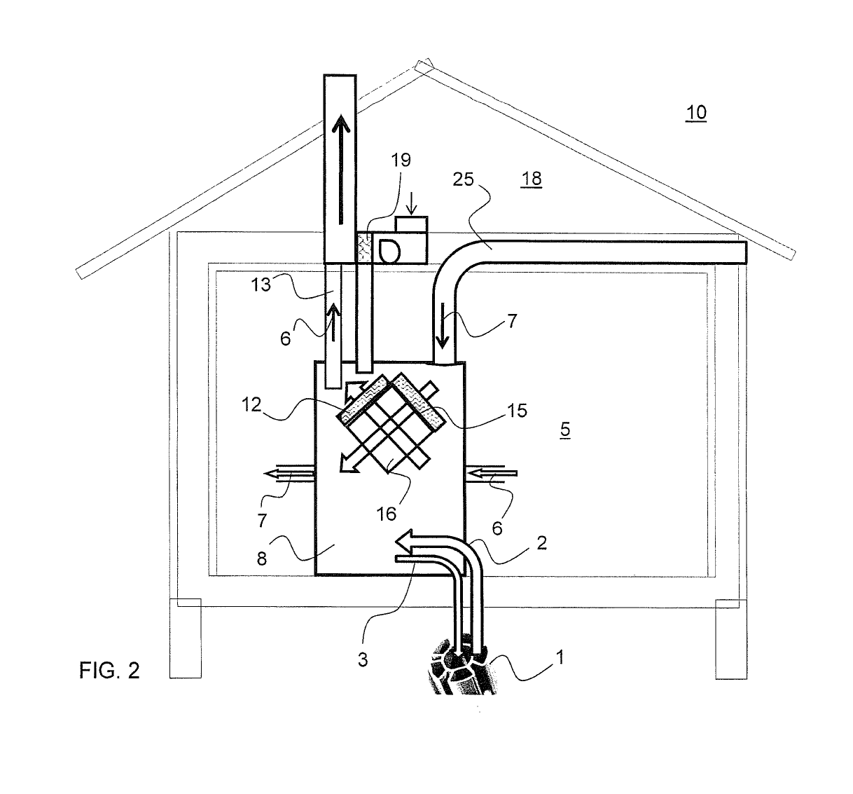

Such an arrangement may have various kinds of structures. FIGS. 1 and 2 show two alternative embodiments, whereby in FIG. 1 the means 12 and 15 for controlling the heat content of air are dispersed, preferably on the outer walls of the building. In this kind of embodiment, these means may be located in the same or a different room space. There may naturally be several means, in which case they are preferably located in pairs in different room spaces 5. In the embodiment of FIG. 2, the liquid radiator 12 and the supply air radiator 15 constitute a part of a ventilation machine 16, which is preferably arranged in the same heat exchanger means 8. The ventilation machine may naturally also be arranged separate from the heat exchanger means, although it is not shown separately in this context.

On the other hand, if the above measurements indicate that the outside air 10 temperature is higher than the inside air temperature of the room spaces 5, the additional circulation of heat transfer liquid via the liquid radiator 12 recovering heat from the flow of air 6 to be removed from the room space and the heating circuit 14 of the accumulator 9 of the heat exchanger means 8 is bypassed. In this case the heat transfer liquid is supplied directly to the supply air radiator 15 controlling the temperature of the air 7 to be supplied to the room space and, in the radiator, heat energy is transferred from the air to be supplied to the room space to the heat transfer liquid. Thus, the temperature of the air 7 to be supplied to the room space is set to a separately definable level.

After the heat transfer liquid has bypassed the supply air radiator 15, it is supplied via the return circuit 3 of the heat exchanger means 8 back to the extraction circuit 1, where it heats as a result of the heat energy released by the heat source.

It is also possible to lead the heat transfer liquid supplied to the return circuit 3 at least partly directly to the supply circuit 2 after the extraction circuit 1 by using a transfer line 3a, as shown by FIG. 4. This extends the period of circulation of the heat transfer liquid in the extraction circuit and gives the heat energy charged in the heat source more time to proceed towards the cooled pipe of the extraction circuit 1 in order to heat the heat transfer liquid circulating therein.

The ability of the extraction circuit 1 to transfer energy is dependent on the flow rate of the heat transfer liquid. When flow becomes turbulent in the extraction circuit, the ability of the heat transfer liquid to bind and release energy improves considerably. Since, on the other hand, it is economical to use standard means, such as liquid and supply air radiators 12 and 15, for collecting and delivering heat, it is advantageous to divide the extraction circuit into at least two paths, as shown by FIG. 4, for instance. In this embodiment, the flow rates for the heat transfer liquid in the arrangement and, particularly, in the liquid radiator 12 collecting heat from the air 6 to be removed from the room space 5 and releasing heat to the air 7 to be supplied to the room space are reasonable. In this case, the heat transfer liquid of the liquid radiator recovering heat energy from the air to be removed may be supplied directly to the extraction circuit. If the heat exchanger means comprises a heat pump, the heat transfer liquid is supplied through this evaporator 11 into the extraction circuit. For the air 7 to be supplied to the room space 5, the heat transfer liquid is supplied to the supply air radiator 15 controlling the temperature of said air to be supplied to the room space, if necessary, via the liquid radiator heating the liquid, wherefrom the heat transfer liquid is further led to the extraction circuit, where the temperature of the heat transfer liquid is set to the level of the extraction circuit.

This second embodiment of the method may also be implemented in such a manner that the flow of heat transfer liquid supplied from the extraction circuit 1 is divided into two or more paths of the supply circuit 2. In this manner, the rate of the heat transfer liquid circulating in the heat source can be doubled or multiplied without having to have larger heat collection and releasing devices in the extraction circuit. The heat transfer liquid circulated by the extraction circuit pump 4 is thus distributed to two or more transfer pipes when it comes from the heat source to the supply circuit. In this case, the liquid radiator 12 recovering the heat from the flow of air 6 to be removed from the room space and the heating circuit 14 of the accumulator 9 of the heat exchanger means 8 are two separate flow circuits in the arrangement according to the method.

In the embodiment of FIG. 4, for instance, the heat energy transferred from the flow of air 6 to be removed from the room space to the heat transfer liquid is continuously supplied via the heat exchanger means 8 and return circuit 3 of the arrangement directly back to the extraction circuit 1. In contrast, when the inside temperature of the room spaces 5 is lower than the outside air 10 temperature, the heat transfer liquid is heated by water supplied to the heating circuit 14 of the accumulator 9 of the heat exchanger means to a target temperature level. The heated heat transfer liquid is supplied to the supply air radiator 15 to control the temperature of the air 7 to be supplied to the room space. When the temperature of the room spaces is higher than the outside air 10 temperature, the operation of the heating circuit 14 is interrupted by, for instance, stopping the supply of water from the accumulator 9 to the heating circuit, and only then is the heat transfer liquid supplied to the return circuit 3 and further to the extraction circuit.

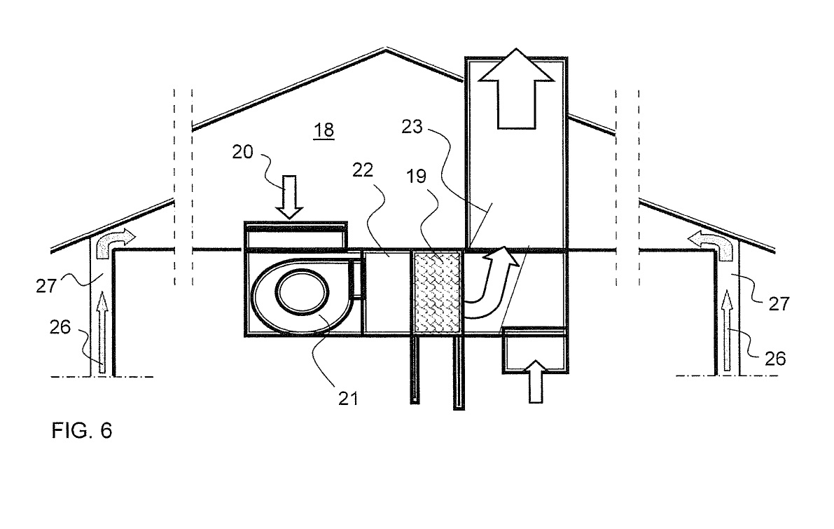

The heat energy content of the heat transfer liquid may also be increased by other heat sources. Such an additional energy source 17 may be an attic 18 of a building, for example. In frosty weather, the temperature of the attic may rise to a temperature of +30 to 50° C. on a sunny day, and even in the night-time its temperature is several degrees higher than that of the outside air 10. By supplying air from the attic to the outside via a liquid radiator 19 formed by a separate additional heat exchanger as shown in FIG. 6, heat can be recovered from this air flow by means of said liquid radiator.

In a third embodiment of the present arrangement according to FIGS. 5 and 6, heat energy is recovered from the additional energy source 17 by, for example, supplying air flow 20 by means of a blower 21 from, in this embodiment, the attic of the building to a preferably insulated duct 22 and the above-described liquid radiator 19 therein that circulates the heat transfer liquid. In this procedure, the blower leading the air flow is preferably heat-regulated in such a manner that it operates with full power when the temperature of the air flowing in the duct and supplied from the attic is above +5° C., and the power becomes constantly lower until the air temperature is −10° C., at which point the blower stops. When the blower stops, a damper 23 mounted in the duct 22 blocks the flow route and prevents the air flow from causing the freezing of the heat transfer liquid in the liquid radiator 19 of the duct.

When, on the other hand, the temperature of the liquid radiator 19 in the duct 22, circulating the heat transfer liquid, is lower than the temperature of the heat transfer liquid to be supplied to the radiator, the heat transfer liquid is arranged to bypass said liquid radiator.

A heat exchanger may also be arranged in the circuit collecting heat energy from an additional energy source 17 in order to preheat household water, as shown by FIG. 5. By supplying the air from the attic 18 to the outside air 10 via the liquid radiator 19 in the duct 22, heat can be recovered from this air flow by means of said liquid radiator. From the liquid radiator, the heat transfer liquid may be supplied to a household water preheater 24 of the heat exchanger means 8, to which the heat transfer liquid releases heat. After this, the heat transfer liquid is returned directly to the extraction circuit or, if the heat exchanger means is a ground-source heat pump, partly or entirely via this evaporator 11 to the extraction circuit.

When the temperature of the heat transfer liquid to be supplied to the evaporator 11 of the heat pump of the heat exchanger means 8 has a temperature allowed by the refrigerant used by the heat pump and the technical solutions of the refrigerant circuit, it is passed through the evaporator, but when the temperature of the heat transfer liquid differs from the allowable temperature, the heat transfer liquid is supplied at least partly past the evaporator directly to the return circuit and further to the extraction circuit.

The present method described above is carried out, for instance, with the arrangement of FIG. 3 comprising the afore-mentioned extraction circuit 1 and the heat transfer liquid circulated therein, the movement of which is controlled by the extraction circuit pump 4 and a control system known per se.

To recover the heat energy contained in the heat transfer liquid and forward it to its site of application, the arrangement includes a supply circuit 2 connected to the extraction circuit 1, and heat exchanger means 8 with the accumulator 9 and preheater 24 thereof.

In addition to these, the arrangement comprises measuring means for determining the outside air 10 temperature and the temperature of the heat transfer liquid supplied from the extraction circuit 1. The arrangement further comprises a liquid radiator 12 for recovering the heat energy from the flow of air 6 to be removed from the room space 5 to the outside air 10. The heat transfer liquid is supplied to this liquid radiator by supply means designed for this purpose.

To receive the water from the accumulator 9 of the heat exchanger means 8, the arrangement preferably comprises a heating circuit 14, to which the heat transfer liquid is supplied by special supply means to guide the heat transfer liquid.

The temperature of the air 7 to be supplied to the room space 5 is arranged to be controlled by the supply air radiator 15, to which the heat transfer liquid is supplied by the supply means designed for this purpose.

Finally the arrangement comprises means for supplying the heat transfer liquid via the heat exchanger means 8 to the return circuit 3 and back to the extraction circuit 1.

In order to divide the flow of heat transfer liquid supplied from the extraction circuit 1 to at least two different paths of the supply circuit 2 formed by a transfer pipe, the arrangement may comprise, for example, a first supply circuit 2a and a second supply circuit 2b, as shown in FIG. 4. In the supply circuit 2a, the heat transfer liquid is thus arranged to be supplied to the liquid radiator 12 recovering heat from the flow of air 6 to be removed from the room space and further to the heat exchanger means 8. In the second supply circuit 2b, the heat transfer liquid is arranged to be supplied to the heating circuit 14 of the accumulator of the heat exchanger means and further to the supply air radiator 15. The heat transfer liquid supplied from the heating circuit to the supply air radiator is passed to the return circuit 3 after the heat exchanger means and further to the extraction circuit 1 in such a manner that the heat transfer liquid that has cooled in the second supply circuit 2b is not arranged to combine with the heat transfer liquid of the first supply circuit 2a supplied from the liquid radiator 12 to the heat exchanger means 8 before the heat exchanger means.

The embodiments of the arrangement shown in FIGS. 5 and 6 comprise an additional heat exchanger for transferring the heat energy recovered from the additional energy source 18 to the heat transfer liquid. A separate heat exchanger may also be arranged in such a circuit collecting heat energy from an additional energy source to preheat household water, in which case the heat energy may preferably be supplied to the preheater 24.

In buildings in which it is not economical to mount a full-scale ventilation system or a channel system suitable for delivering and collecting air, ventilation may be provided as in FIG. 1 by supplying air 7 to the room space 5 through an opening or duct made for this purpose and by removing the air from the room space through an opening made to the opposite wall or roof. The temperature of the air 7 supplied to the room space is adjusted to the same level as the temperature of the room space by means of the supply air radiator 15 in the system. The liquid radiator 12 recovers heat from the air 6 to be removed from the room space in order to heat the incoming outside air or household water, if such an option is provided in the system. In this embodiment, both the ducts supplying air to the room space and the ducts removing air from the room space preferably include their own blowers, by which air is transferred to the liquid and supply air radiators.

The heat controlling means of the present system are particularly suitable for use in modern buildings which use ventilation ducts for ventilation and possibly also for heat distribution and which have a ventilation system with a section transferring heat from the air 6 to be removed from the room space to the air 7 to be supplied to the room space 5. The supply air radiator 15 for the air 7 to be supplied to the room space may be mounted in the supply air duct of the building before the heat recovery section 16, as shown by FIG. 1, whereupon the temperature of the air to be supplied to the room space may be raised during the cold season to a sufficiently high level in order to maximize the effect of the heat recovery section in the ventilation device and to prevent freezing. In the heat recovery section, the air temperature must be at least about +2° C., whereby the condensation of air 6 to be removed from the room space is sufficient but the air cannot freeze. In the heat recovery section, the air to be supplied to the room space heats up to a temperature of +10 to 15° C., depending on the size of the section and the temperature of the exhaust air. If necessary, the air 7 to be supplied to the room space 5 may also be adjusted to a temperature required by the inside air by means of special post-heating.

Cooling of a room space of a building in the summertime may be further increased when part of the heat transfer liquid to be supplied to the supply air radiator 15, the temperature of which is lower than that of the air of the room space 5, is supplied to a separate blowing radiator in the room space.

The ventilation of the building prevents the harmful effects of outside air humidity on the structures especially during the warm season. In the present arrangement, it is advantageous to use ventilation air 26 for the structures shown in FIG. 6 for transferring energy exiting through the envelope of the building or solar energy collected in the envelope to the liquid radiator 19 recovering heat. According to FIG. 6, the ventilation air is preferably supplied along vent holes 27 in the structures to a substantially closed attic space 18. The ventilation air is removed from the building by the blower 21, the blowing power of which can be adjusted as was described above. Thus, at a temperature of above +5° C., the blower removes air with full power. When the temperature of the attic is +5 to −10° C., the blowing power of the ventilation blower is reduced continuously until it stops entirely when the temperature of the attic is −10° C. A ventilation air filter and a butterfly damper 23 prevent the freezing of the duct 22 portion by preventing or considerably reducing the movement of air between said parts. The stopping of the blower also prevents the movement of air in the vent hole 27 to some extent or entirely, and the formed air column improves the thermal insulation capacity of the structure.

During the warm season, the temperature of the heat transfer liquid receiving heat of the liquid radiator 12 recovering the heat of the air 6 to be removed from the room space 5 is lower than the temperature of the air 7 that comes from the outside air 10, which contains relatively much humidity and is to be supplied to the room space, and thus the heat is transferred efficiently to the heat transfer liquid due to the condensation that takes place in the liquid radiator. The condensed water is supplied to the sewer system of the building by simple means.

It is obvious to a person skilled in the art that, as technology advances, the basic idea of the invention may be implemented in many different ways. The invention and its embodiments are thus not restricted to the examples described above, but may vary within the scope of the claims.

1. A method for using a low-energy source for controlling the air temperature in a room space, wherein an arrangement for collecting low energy comprises
an extraction circuit (1),
a heat transfer liquid circulated in the extraction circuit,
an extraction circuit pump (4) and a control system for controlling movements of the heat transfer liquid, and,
connected to the extraction circuit, a supply circuit (2) and heat exchanger means (8) with accumulators (9) for recovering heat energy, wherein
heat energy obtained from a heat source, such as the ground, rock, sediments of water bodies, or water bodies, is extracted by the heat transfer liquid by using an efficient extraction circuit pump,
the ratio of the desired inside air temperature in room spaces (5) to the outside air (10) temperature is determined, and
the temperature of the heat transfer liquid coming from the extraction circuit (1) is determined,
and when the temperature of the room spaces is higher than the outside air temperature and the temperature of the heat transfer liquid is low compared to the heating demand of the air to be supplied from the outside to the room spaces, the heat transfer liquid is supplied by means of a control device to an additional circulation, to a liquid radiator (12) recovering the heat from the air to be removed from the room spaces, where more heat energy is transferred to the heat transfer liquid, after which
the heat transfer liquid is supplied further to a heating circuit (14) connected to an accumulator (9) of the heat exchanger means to be heated and to achieve a target temperature level, or
when the outside air temperature is higher than the temperature of the room spaces, the additional circulation of heat transfer liquid via the liquid radiator (12) recovering heat from the air to be removed and the heating circuit (14) of the accumulator (9) of the heat exchanger means is bypassed,
after which the heat transfer liquid having the target temperature level is supplied to a supply air radiator (15) controlling the temperature of the air (7) to be supplied to the room space (5), whereby
the heat transfer liquid adjusts the temperature of air to be supplied to the room space to a separately definable level to maintain a substantially even temperature in the room space and to avoid the feeling of draught caused by the air to be supplied to the room space, and
the heat transfer liquid is supplied via a return circuit (3) of the heat exchanger means back to the extraction circuit (1), where it heats as a result of the heat energy released by the heat source,
characterized in that
the flow of heat transfer liquid supplied from the extraction circuit (1) is divided into two or more paths of the supply circuit (2a, 2b), whereby the rate of the heat transfer liquid circulating in the heat source may be at least doubled without having to have larger heat collection and releasing devices as part of the extraction circuit,
and when the heat transfer liquid circulated by the extraction circuit pump (4) comes from the heat source, it is distributed to two or more transfer pipes, where the heating circuits (14) of the liquid radiator (12) recovering the heat from the air to be removed and of the heater (9) of the heat exchanger means (8) are in different flow circuits in such a manner that
the heat energy transferred from the air (6) to be removed to the heat transfer liquid is continuously supplied via the heat exchanger means (8) and return circuit (3) of the arrangement back to the extraction circuit (1), and when the temperature of the room spaces (5) is lower than the outside air (10) temperature, the heat transfer liquid is heated to the target temperature level in the heating circuit (14) of the accumulator of the heat ex-changer means, and the heated heat transfer liquid is supplied to the supply air radiator (15) to control the temperature of the air (7) to be supplied to the room space, or
when the temperature of the room spaces is higher than the outside air temperature, the operation of the heating circuit (14) is interrupted, after which the heat transfer liquid is supplied to the return circuit (3) and further to the extraction circuit (1).

2. A method as claimed in claim 1, characterized by
passing the heat transfer liquid supplied to the return circuit (3) at least partly directly to the supply circuit (2) after the extraction circuit, which gives the heat energy charged in the heat source time to proceed towards the cooled pipe of the extraction circuit in order to heat the heat transfer liquid circulating therein.

3. A method as claimed in claim 1, characterized by
further heating the heat transfer liquid to be supplied from the liquid radiator (12) for the air (6) to be removed by the heat energy that is supplied thereto from an additional energy source (17), which may be an attic space (18) of a building, and
supplying the heat energy recovered from the additional energy source to at least one liquid radiator (19) formed by an additional heat ex-changer transmitting heat transfer liquid.

4. A method as claimed in claim 2, characterized by
recovering the heat energy from the additional energy source (17) by supplying an air flow (20) by means of a blower (21) from there to a duct (22) and a liquid radiator (19) therein that circulates the heat transfer liquid.

5. A method as claimed in claim 3, characterized in that
the blower (21) controlling the air flow (20) is heat-regulated in such a manner that it operates with full power when the temperature of the air (20) in the duct (22) is above +5° C., and the power becomes constantly lower until the temperature is −10° C., at which point the blower stops and
a damper (23) mounted in the duct (22) blocks the flow route and prevents the air flow from causing the freezing of the duct.

6. A method as claimed in claim 5, characterized in that
the heat transfer liquid is arranged to bypass the liquid radiator (19) in the duct (22), circulating the heat transfer liquid, when the temperature of the liquid radiator is lower than the temperature of the heat transfer liquid obtained from the duct.

7. A method as claimed in claim 3, characterize d in that
a heat exchanger is arranged in a circuit collecting heat energy from the additional energy source (17) to preheat household water, whereby
the heat transfer liquid is supplied via the liquid radiator (19) in the duct (22), thereby recovering heat from the air flow in the channel,
from which liquid radiator the heat transfer liquid is supplied to a household water preheater (24) of the heat exchanger means (8), to which the heat transfer liquid releases heat, and
the heat transfer liquid is supplied further via the return circuit (3) of the arrangement back to the extraction circuit (1).

8. An arrangement for using a low-energy source for controlling the inside air temperature in a room space (5), the arrangement comprising
an extraction circuit (1),
a heat transfer liquid circulated in the extraction circuit,
an extraction circuit pump (4) and a control system for controlling movements of the heat transfer liquid, and,
connected to the extraction circuit, a supply circuit (2) and heat exchanger means (8) with accumulators (9) for recovering heat energy,
measuring means (10) for determining the outside air (10) temperature and the temperature of the heat transfer liquid supplied from the extraction circuit (1),
a liquid radiator (12) for recovering heat from air (6) to be removed from the room space (5),
means for supplying the heat transfer liquid to said liquid radiator (12),
a heating circuit (14) connected to the accumulator (9) of the heat exchanger means (8),
means for supplying the heat transfer liquid to said heating circuit, \
a supply air radiator (15) controlling the temperature of the air (7) to be supplied to the room space (5),
means for supplying the heat transfer liquid to said supply air radiator,
means for supplying the heat transfer liquid via the heat exchanger means (8) to the return circuit (3) and further back to the extraction circuit (1),
characterized in that
the flow of heat transfer liquid supplied from the extraction circuit (1) is arranged to be divided into at least two paths (2a, 2b) of the supply circuit formed by a transfer pipe, whereby
in the first supply circuit (2a), the heat transfer liquid is arranged to be supplied to the liquid radiator (12) recovering the heat from the air (6) to be removed and further to the heat exchanger means (8), and
in the second supply circuit (2b) the heat transfer liquid is arranged to be supplied to the heating circuit (14) connected to the accumulator (9) of the heat exchanger means (8) and further to the supply air radiator (15) in such a manner that
the heat transfer liquid supplied from the heating circuit (14) to the supply air radiator (15) is passed to the return circuit (3) after the heat ex-changer means (8) and further to the extraction circuit (1) so that the heat transfer liquid that has cooled in the second supply circuit (2b) is not arranged to combine with the heat transfer liquid of the first supply circuit (2a) supplied from the liquid radiator (12) to the heat exchanger means (8) before the heat exchanger means.

9. An arrangement as claimed in claim 8, characterized in that
the arrangement comprises a liquid radiator (19) forming an additional heat exchanger for transferring the heat energy recovered from the additional energy source (17) to the heat transfer liquid.

10. An arrangement as claimed in claim 9, characterized in that
the heat energy of the additional energy source (17) is arranged to be supplied to the liquid radiator (19) forming the additional heat exchanger by means of a blower (21).

11. An arrangement as claimed in claim 10, characterized in that
the blower (21) is heat-regulated in such a manner that it is arranged to operate with full power when the temperature of the additional energy source (17) is above +5° C., and the power becomes constantly lower until the temperature of the additional energy source has decreased to −10° C., at which point the blower is arranged to stop,
and a duct (22) receiving the liquid radiator (19) comprises a damper (23) for blocking the flow route.

12. An arrangement as claimed in claim 11, characterized in that
the heat transfer liquid is arranged to bypass the liquid radiator (19) when the blower (21) has stopped.

13. An arrangement as claimed in claim 9, characterized in that
the liquid radiator (19) collecting heat energy from the additional energy source (17) comprises a circuit for preheating household water.
